(19) United States
(12) Patent Application Publication
(10) Pub. No.: US 2006/0105746 A1
(43) Pub. Date: May 18, 2006

(54) Controlling communication equipment

(75) Inventors: Hannu I. Pirila, Littoinen (FI); Harri Jokinen, Pertteli (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/261,621

(22) Filed: Oct. 31, 2005

(30) Foreign Application Priority Data
Nov. 2, 2004 (GB) 0424261.6

(51) Int. Cl. H04M 1/66

(52) U.S. Cl. 455/411; 455/422.1

(57) ABSTRACT

A method controls use of a user equipment. The method includes switching a wireless user equipment into a mode wherein the capability of the wireless user equipment to select an access network from available access networks is restricted. The method also includes sending from an allowable access network control instructions to the wireless user equipment. The operation of the wireless user equipment is then controlled based on control instructions received from the allowed access network.

### BACKGROUND OF THE INVENTION

1. Field of the Invention

The present disclosure relates to control of communication equipment, and in particular, but not exclusively, to control of use of user equipments adapted for communication in an environment where access to a communication system normally used by the user equipment may be restricted.

2. Description of the Related Art

A communication system can be seen as a facility that enables communication sessions between two or more entities such as user equipment and/or other nodes associated with the communication system. The communication may comprise, for example, communication of voice, data, multimedia and so on. A user equipment connected to a communication system may, for example, be provided with a two-way telephone call or multi-way conference call or with a data connection. A user equipment may communicate packet data to and/or from a server entity, or to and/or from at least one other user equipment.

Communication systems providing wireless communication for user equipment are also known. These systems are commonly referred to as mobile systems or wireless access systems. An example of the mobile systems is the public land mobile network (PLMN). A PLMN is commonly based on cellular architecture. Mobility and/ore wireless access may also be provided, at least partially, by means of communication satellites. In certain systems the mobility may be restricted to small areas, examples of such wireless access systems including wireless local area networks (WLAN) and local cordless telephone systems.

In a common wireless system an access network serves a plurality of user equipment. The access network (AN) enables the user equipment to access the core part of a communication network that links the access network to other access networks or communication networks. Each access network is provided with at least one controller which may be connected to appropriate core network entities. For example, the third generation (3G) Wideband Code Division Multiple Access (WCDMA) networks employ access network control entities known as radio network controllers (RNC). In the second generation (2G) GSM (Global System for mobile) the access network is understood to be controlled by a base station controller (BSC). One or more gateway nodes may be provided for connecting the core network part of a network to other networks. For example, a mobile core network may be connected to other mobile or fixed line communication networks or communication networks such as an IP (Internet Protocol) and/or other packet data networks.

Typically a wireless access network is provided with at least one station, commonly referred to as a base station. A user equipment may communicate wirelessly with two or more stations and/or access networks at the same time. Communication on the wireless interface between the user equipment and the access network can be based on an appropriate communication protocol.

Mobile communication systems have proven very popular. A great number of users are using routinely their mobile user equipment, especially cellular telephones, when and where ever required. However, there are locations and situations where the use of mobile user equipment may not be appropriate. For example, use of mobile user equipments in an aircraft may cause a safety risk because of the sensitivity of the electronics of the aircraft (“avionics”) to electromagnetic radiation emitted by the mobile user equipment. Similarly, electronic equipment in environments such as ships, hospitals, monitoring and/or control rooms, laboratories and so on may be disturbed by radiation from mobile user equipment.

On the other hand, a growing number of users would like to communicate even when in environments such as aircrafts, ships, hospitals and so forth. Attempts to meet this demand have included installation of special phone systems for these places. However, the users have not always been willing to use these systems. The reasons for reluctance include inconvenience caused by, for example, the lack of address/phone book features of the common telephones and unfamiliarity of the operation of the system. Some users may have been put off by the presumption that the usage of such systems is costly.

A number of studies have been carried out to investigate the possible risks, especially in the field of aircrafts and hospitals. These studies show that, under the right conditions, it is believed to be safe to allow the use of mobile user equipment in an environment such as onboard an aircraft or in a hospital. This has lead to suggestions that the users should be able to use their own terminal equipment in such environments if the wireless access can be provided by a system that is known to be safe. The access system should also preferably be controlled by a body who is has the responsibility over the safety of the environment.

There are also other, less technical but nevertheless important reasons why use of mobile user equipment may not be appropriate in all locations or at east not all the time in certain locations. For example, cellular telephones may unwittingly disturb occasions such as concerts, plays, speeches and so on. Some people might prefer if use of mobiles would not be allowed all the time in public places such as train carriages, busses, waiting rooms, art galleries and so on. A yet another example is occasions where a user needs to be at least temporarily isolated from the others. Such situations may arise, for example, during an exam or in a prison. In all these occasions it would help if it could be possible to limit or otherwise control use of mobile user equipment.

The following considers some problems with this need with reference to a proposal for a service permitting use of mobile user equipment when onboard an aircraft. The proposed concept is based on the idea of having a specific onboard access network which is linked to a ground based communication system. This allows controlled wireless traffic between the aircraft and the ground instead of uncontrolled traffic between individual mobile stations and a plurality of access networks on the ground. For this type of a service a body other than the actual operator of a subscriber may act as the mobile roaming operator operating the onboard access network. As such the body need not to have any subscribers of its own but may provide “real” operators with the possibility to offer roaming services to their subscribers when they are onboard an aircraft. A user onboard is enabled to switch on his/her wireless user equipment during the flight and use the user equipment to initiate and receive communications in the same way as when roaming in a visited network.

It may be necessary to ensure that a user equipment remains in the flight safe mode once this mode has been selected, and that a user should not be able to switch off the flight safe mode during the flight, either intentionally or unintentionally. This may be especially important if the onboard system is such that it is checked only once or only a few times if any mobile user equipment are in an improper mode, where after it is assumed that the state of any user equipment does not change.

Furthermore, it may need to be ensured that a user equipment does not interfere with any aviation equipments or electronics during certain stages of the flight, such as take off, landing, time of turbulence or when changing altitude or flight path. It may be required in certain occasions that the user should not be able to use the user equipment during such times at all, even in the flight safe mode. Furthermore, it might be useful to provide an indication for the user if the use of the user equipment is or is not allowed.

It is appreciated that the problem of uncontrolled use, intentional or unintentional, is not limited to aircrafts and aviation environments. Similar needs may exist in any environment where there is a need to control wireless access by user equipments. In addition to cellular systems, these problematic issues may need to be solved in other wireless access technologies, such as WLAN and Bluetooth.

### SUMMARY OF THE INVENTION

Embodiments of the present invention aim to address one or several of the above problems.

According to one embodiment, there is provided a method for controlling use of a user equipment. The method comprises the steps of switching a wireless user equipment into a mode wherein the capability of the wireless user equipment to select an access network from available access networks is restricted and sending from an allowable access network control instructions to the wireless user equipment. The operation of the wireless user equipment is then controlled based on control instructions received from the allowed access network.

According to another embodiment, there is provided a system for controlling use of user equipments in the service area of an access network connected to a communication system. The system comprises a transmitter of the access network for wireless communication of control instructions to user equipments. User equipments are configured to have a mode of operation wherein the capability of the user equipments to select an access network from available access networks is restricted. The user equipments are also configured to operate based on control instructions received from an allowed access network.

According to another embodiment, there is provided an access network for serving at least one wireless user equipment that is switched into a mode wherein the capability of the at least one wireless user equipment to select an access network from available access networks is restricted. The access network is configured to send control instructions to the at least one wireless user equipment for controlling the operation of the wireless user equipment for preventing inappropriate use of the at least one user equipment within the service are of the access network.

According to a still another embodiment, there is provided a controller for controlling use of user equipments within an access network which is configured to serve at least one wireless user equipment that is switched into a mode wherein the capability of the at least one wireless user equipment to select an access network from available access networks is restricted. The controller is configured to generate control instructions to the at least one wireless user equipment for controlling the operation of the wireless user equipment for preventing inappropriate use of the at least one user equipment within the service area of the access network.

According to yet another embodiment, there is provided a user equipment that comprises a radio part for communication with access networks. The user equipment also comprises a controller configured to enable switching of the user equipment into a mode wherein the capability of the user equipment to select an access network from available access networks is restricted, to receive from an allowable access network via the radio part control instructions, and to control operation of the user equipment based on control instructions received from the allowed access network.

The embodiments of the invention may provide a way of controlling against unwanted use of wireless user equipment. An advantage is that a wireless user equipment may remain forcedly under control of a local access network as long as it is located within the service area of the local access network if so desired. This may enable arrangements wherein it is not necessary to arrange any additional checks or monitoring for inappropriately used wireless user equipments after the safety status of user equipments has been checked once. In certain embodiments wireless access and/or use of user equipment may be limited during specific time periods within a specific access environment. In certain embodiments a user of a user equipment may be provided with an indication by incompatible user equipment of user equipment in incorrect mode of operation may be prevented.

### BRIEF DESCRIPTION OF DRAWINGS

For better understanding of the present invention, reference will now be made by way of example to the accompanying drawings in which:

FIG. 1 shows a system embodying the present invention;

FIG. 2 is a flowchart illustrating an embodiment of the present invention; and

FIG. 3 is a sectional view of a user equipment.

### DETAILED DESCRIPTION OF THE PREFERRED EMBODIMENTS

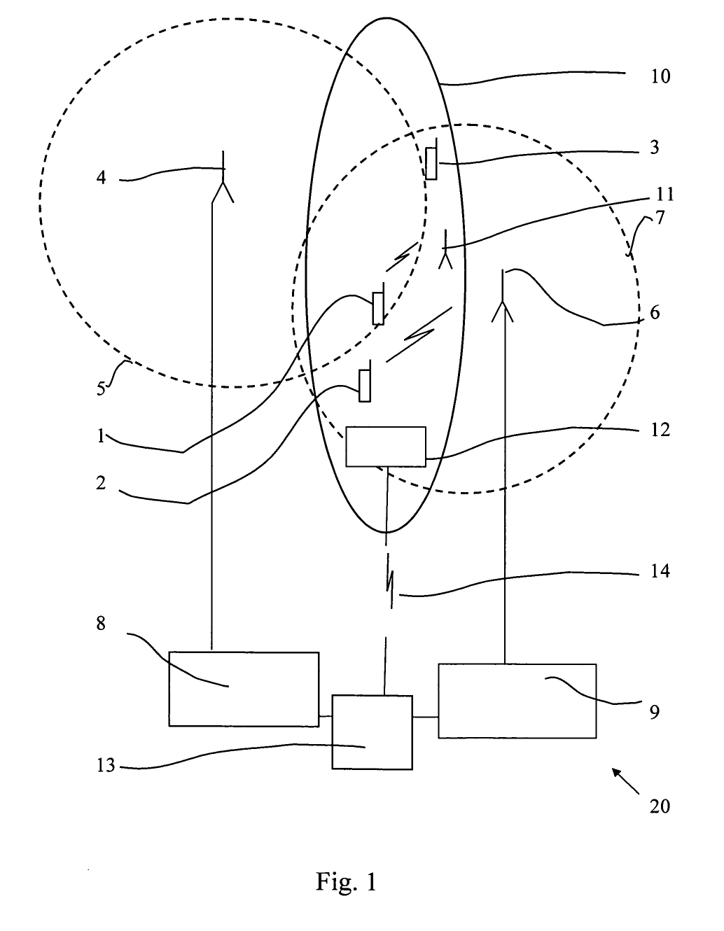

A reference is first made to FIG. 1 illustrating a mobile communication system wherein the present invention may be embodied. The underlying mobile communication system 20 of FIG. 1 may be provided by a plurality of known mobile communication networks, and may be operated by different operators.

In a typical mobile communication network, for example a public landline mobile network (PLMN), a number of access networks 5 and 7 is provided by means of base stations 4 and 6. Each of the base stations of the access networks is arranged to wirelessly transmit signals to and receive signals from a plurality of mobile user equipment 1, 2 and 3. Such PLMN access networks are commonly referred to as cells, hence the name cellular systems.

Only two access networks 5 and 7, base stations 4 and 6, and access network controllers 8 and 9 of the communication system 20 are shown in FIG. 1 for clarity. The wireless communication between the user equipment 1 to 3 and the access networks can be based on any appropriate communication protocol and access technology. Non-limiting examples include access based on systems such as the CDMA (Code Division Multiple Access), WCDMA (Wide-band CDMA), TDMA (Time Division Multiple Access), FDMA (Frequency Division Multiple Access), or SDMA (Space Division Multiple Access) and hybrids thereof.

Likewise, each of the mobile user equipment 1 to 3 is able to transmit wireless signals to and receive signals from appropriate access network. An appropriate user equipment is provided with required radio transmission elements and controller functions so that it is enabled to send and receive data from the access networks, and process control instructions it may receive from an access network and to transmit control information to an access network.

A mobile user equipment is able to move within an access network and also from one access network to another access network. In addition, a mobile user equipment may also be enabled to roam into another communication network of the mobile communication system. The basic principle of roaming was already described above, and is hence not repeated in here.

The architecture of the overall communication system of FIG. 1 for onboard passengers is comprised of the element of an airborne system, an air to ground interface 14, and a ground infrastructure 20. The two last mentioned may be based on any appropriate conventional systems, and therefore the following will focus on the airborne system.

FIG. 1 shows an onboard access network 10. In the exemplifying embodiment the onboard access network approximately corresponds to the interior of an aircraft. The access network is shown to be provided by a base station 11. It will be understood that in a practical application the number of onboard base stations may need to be greater than one. Operation of the access network 10 is controlled by onboard controller 12. As show by FIG. 1, the onboard controller 12 may be in communication with the elements of the land based communication system 20 via an appropriate gateway node 13 and wireless interface 14.

The onboard system is configured to handle communications with the wireless user equipment 1 to 3 on-board the aircraft and connects to the ground system, for example via a satellite unit. The onboard system may use architecture that can be compared to that used for mobile communication on the ground. It has been proposed that the onboard system should be compliant with at least one existing standard such that it is compliant with the roaming framework rules to allow procedures such as automatic user registration and billing.

In accordance with the roaming rules, a mobile user equipment, when in standby or idle modes, may listen to the surrounding access networks. In normal mode of operation, if an access network has been detected by a user equipment, the user equipment tries to connect to the access network using a transmitted power as indicated by the access network, for example in a system broadcast message. The user equipment then transmits only up to the maximum power level indicated by the network. This makes it possible to limit the transmission power of a user equipment to a level that is believed to be safe for a particular environment, for example an aircraft, if a discrete access network, for example a cell, is created within the aircraft. Most mobile user equipment such as cellular phones have a transmitted power range from a milliwatt to up to two watts, and if an aircraft carries its own cell, the amount of power needed by mobile user equipment to connect will be minimal, thus reducing the amount of electromagnetic radiation and therefore considerably reducing the risk of interference with the avionics of the aircraft.

More particularly, the mobile user equipment 1 to 3 of the example of FIG. 1 are switched to an appropriate safety mode in which they can only communicate via the base station 11 of the onboard access network 10. The switching may occur either manually or automatically at about the time of boarding the aircraft or when preparing for the take-off.

In such safety mode or any other “free access” prevention mode a user equipment only seeks for attachment to a predefined access network or networks. A user equipment in such a mode will not even try to attach to other networks. In the following this mode will be referred to as “flight safe mode”. In FIG. 1 this means that the user equipments in a flight safe mode will not seek for registration with the networks 5 or 7. Instead, the user equipments will seek for registration with the onboard access network 10.

If a user equipment is for example switched off and on it may happen that it becomes active in a “wrong” mode, and will then seek for registration with any access network. To ensure that the user equipment stays in a proper mode, the onboard access system may broadcast appropriate control information. For example, when a user equipment has once attached to an access network that provides a flight safe mode service, and flight safe mode operation of the user equipment has been switched on, the user equipment refrains from seeking for registration in any other access network and/or PLMN as long as the previously registered flight safe mode supporting access network indicates to the user equipment that it shall still remain in a flight state. In this context the flight state indicator refers to an indicator of an state during which no other network is allowed to be used.

If a user equipment in a flight safe mode is switched off, when it is camped in an onboard access network in the flight state, and then switched on again, the user equipment may first check if the onboard access network is still available before switching off the flight safe mode. It is only after this check when another network can be selected.

The flight safe mode may stay activated until the onboard system signals deactivation. It is preferred that it should not be possible for a user to manually deactivate the flight safe mode once it is activated and if the controlled restriction is still active from the serving network. However, a manual deactivation of the flight safe mode might be desired is some applications. In the latter case it is preferred to limit the possibility of manual deactivation to instances where network authentication is not supported, by the user equipment and/or the network, thereby preventing the user from being forced to a false base station. The deactivation, however, should preferably not overrun instructions from the onboard system for safety reasons. The deactivation may also be automatic, and be triggered, for example, by the arrival to destination. After deactivation normal registration to any suitable network is again possible.

The implementation of the above may be provided by means of an extension to existing PLMN and cell selection algorithms. For example, when the flight safe mode is switched on, the user equipment will detach from the current network and will attach only to a flight safe mode cell or other safe access entity. This functionality may be provided in a manner similar to the manual PLMN selection, choosing the flight safe mode as the PLMN to be used. In case no specific PLMN code is used for this purpose, the user equipment may in this case search for a cell that indicates flight safe mode support in a manner similar to searching for a specific PLMN in the case of the manual PLMN selection.

Existing broadcast parameters, or safe mode specific parameters can be used for communication of control instructions between the onboard system and the user equipments.

In accordance with a further embodiment an indication can be send from an access network to control periods when a user equipment can be used and/or when it cannot be used. For example, an indication may be broadcast in the onboard access system regarding the time when the user equipments are allowed to be used for any activity. The activities may include, in addition to voice calls or data connections, operations such as periodic location updates and so on. Other functionalities that may be temporarily disabled may include applications such as personal data assistants, games, music players and so on.

According to a possibility an appropriate indication, for example a control bit, is set to an allowed state, and broadcast in the onboard system. The user equipments which are onboard and in flight safe mode are then allowed to start speech calls, data connections and so on. Correspondingly, when the control bit is set to prevention state, the user equipments are not allowed to start any radio activity, or other activities, as the case may be.

An advantage of this kind of control is that the user equipments on board can be stayed inactive during specific periods such as takeoff and landing or any other similar situation. For complete cover of user equipments the feature may need to be standardised by appropriate other authorities.

It may need to be made easy to inspect if the user equipments onboard support for this feature. This can be provided, for example by attaching a label on the user equipment in order to allow easy detection of allowed user equipment.

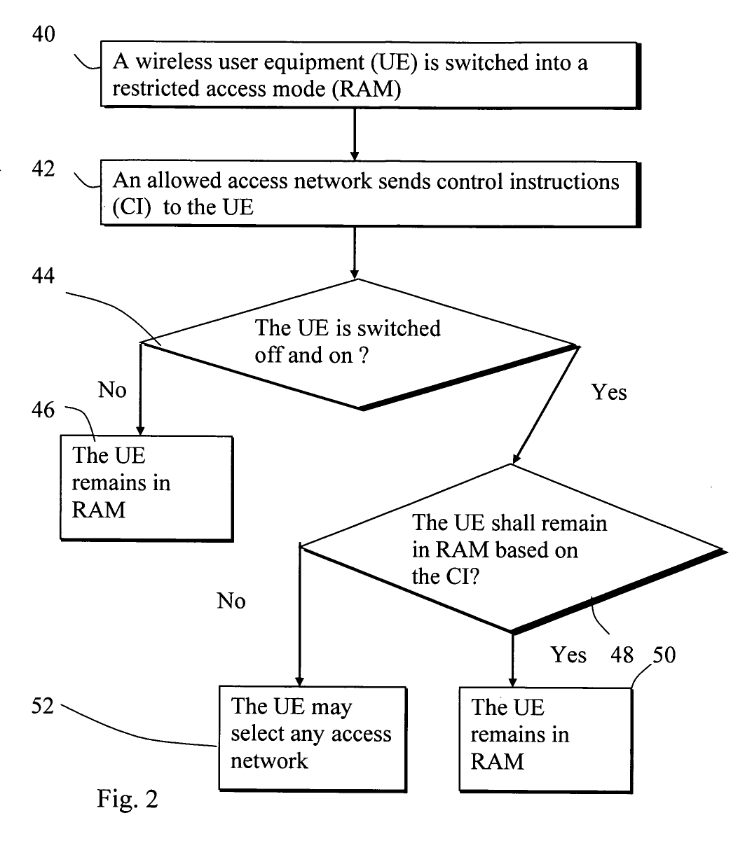

A reference is now made to the flowchart of FIG. 2. In step 40 a user equipment is switched to a mode wherein it may access only predefined networks. This may occur, for example, before the take-off of an aircraft, for example in response to cabin attendants request to power-off user equipment or alternatively switch then to a flight safe mode. The user equipment detaches from the current network and attaches to the onboard flight safe mode system. The user equipment is then under control of the aircraft's own communication system, i.e. controller 12 of FIG. 1.

Transmission of control signals at step 42 enables various control functionalities during the flight. As explained above, a user equipment may be switched off and on during the flight, step 44. When the user equipment switched on again, the user equipment may first check at step 46 if the onboard access network is still available from the control signals from the access network before switching off the flight safe mode. It is only after this check when another network can be selected at step 52, otherwise the user equipment will remain in the flight safe mode.

After arrival the flight safe mode may be automatically deactivated by changing the broadcast parameter settings where after the user equipment may return to their normal behavior. Signaling from a user equipment that is in a predefined mode limiting its access to a specific access network is received by the access network.

A user equipment may automatically activate the flight safe mode in response to detection of an access system supporting the flight safe mode, for example from a restricted flight safe mode indication. To avoid service attacks from false base stations, the automatic flight safe mode selection may be limited to cases when the user equipment can reliably authenticate the network. Automatic activation may also be achieved by means of a jammer. The jammer cam be used to block all other cellular channels, except the one used for the flight safe mode. This may be done by transmitting wide band noise on the full cellular spectrum, from the same antenna as the cellular carrier but at a level sufficiently lower than the useful signal. Because of this the user equipments are automatically dropped from the current networks and attach to flight safe mode cell. After the attachment the user equipments will notice flight safe mode availability and will automatically camp on the flight safe mode cell, and optionally switch to flight safe mode, if this is desired.

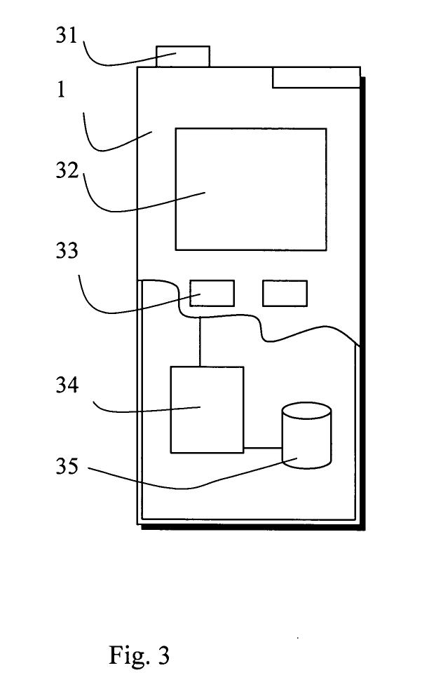

An example of a wireless user equipment 1 is shown in the sectional view of FIG. 3. The user equipment comprises necessary radio equipment 31 for wireless communication with access networks. A display 32 is provide for displaying information such as the above referenced state indication to the user. The user may control the operation of the user equipment by means of the control buttons 33. A controller 34 is provided for controlling the operation of the user equipment. A database 35 for storing data may also be provided.

The required data processing functions may be provided by means of one or more data processor entities. At least a part of the processing may be provided in the controller 12 of FIG. 1. At least a part of the processing may also be provided in a user equipment. Processing of the control functions may be distributed between a controller of the access network and a controller of the user equipment separated.

Appropriately adapted computer program code product may be used for implementing the embodiments, when loaded to a computer, for example for computations required when monitoring for improperly switched user equipments and analysis of the users thereof. The program code product for providing the operation may be stored on and provided by means of a carrier medium such as a carrier disc, card or tape. A possibility is to download the program code product via a data network. Implementation may be provided with appropriate software in a server.

The above discloses an access network arrangement wherein support for a specific mode can be indicated for user equipment. A specific indication bit and/or a globally defined safe mode PLMN may be defined and broadcast within system information for such purposes. A broadcast indicator may also be used to force the user equipments onboard to stay on the access network supporting the mode. The user equipment may be forced to stay in this mode during a specific period, for example when terrestrial networks shall not be accessed. The ban may then be lifted immediately when access to terrestrial networks may be allowed again even if the specific access network is still available, as long as it does not indicate any forced mode operation.

It should be appreciated that whilst embodiments of the present invention have been described in relation to user equipment such as mobile telephones, embodiments of the present invention are applicable to any other suitable type of user equipment that may be used for wireless access.

The onboard system or any other system providing a local forced access network system may include a number of access network, for example a number of cells.

It is understood that other embodiments of the invention are possible, while remaining within the scope of the invention. It is noted that even though the exemplifying communication system shown and described in more detail in this disclosure uses the terminology of the 2^{nd} generation (2G) and 3^{rd} generation (3G) WCDMA (Wideband Code Division Multiple Access) networks, such as the GSM, UMTS (Universal Mobile Telecommunications System) or CDMA2000 public land mobile networks (PLMN), embodiments of the proposed solution can be used in any communication system providing wireless access for users thereof wherein access of any user equipment may need to be somehow controlled.

It is also noted herein that while the above describes exemplifying embodiments of the invention, there are several variations and modifications which may be made to the disclosed solution without departing from the scope of the present invention as defined in the appended claims.

1. A method for controlling use of a user equipment, the method comprising:
switching a wireless user equipment into a mode wherein a capability of the wireless user equipment to select a selectable access network from available access networks is restricted;
sending control instructions from an allowable access network to the wireless user equipment; and
controlling operation of the wireless user equipment based on the control instructions received from the allowable access network.

2. A method as claimed in claim 1, wherein the step of sending control instructions comprises sending instructions for the wireless user equipment to remain in said mode wherein the capability to select the selectable access network is restricted.

3. A method as claimed in claim 1, wherein the step of sending control instructions comprises broadcasting the control instructions in the allowable access network.

4. A method as claimed in claim 1, comprising the step of checking in the wireless user equipment if the wireless user equipment needs to operate in said mode wherein the capability to select the selectable access network is restricted subsequent to switching the wireless user equipment into an active state.

5. A method as claimed in claim 1, wherein the step of controlling the operation of the wireless user equipment comprises overriding a default operation of the wireless user equipment by the operation in accordance with the control instructions received from the allowable access network.

6. A method as claimed in claim 1, comprising the step of automatically activating or deactivating said mode wherein the capability to select the selectable access network is restricted in response to a predefined event.

7. A method as claimed in any claim 6, wherein said step of automatically activating or deactivating occurs in response to at least one of entering the wireless user equipment in the allowable access network, receiving a trigger signal from the allowable access network, and jamming of at least one non-allowable access network.

8. A method as claimed in claim 1, wherein the step of sending control instructions comprises sending instructions regarding restrictions of use of the wireless user equipment.

9. A method as claimed in claim 8, wherein the step of sending instructions regarding restrictions of use of the wireless user equipment comprises sending timing information.

10. A method as claimed in claim 8, wherein the step of sending instructions regarding restrictions of use of the user equipment comprises sending information regarding allowable or non-allowable functions of the wireless user equipment.

11. A method as claimed in claim 1, wherein the step of switching comprises switching the wireless user equipment into said mode wherein the wireless user equipment is restricted from accessing networks other than an onboard access network of an aircraft.

12. A method as claimed in claim 1, comprising the step of enabling selection by the user equipment of an access network in response to determination that the allowable access network cannot be authenticated.

13. A computer program embodied on a computer-readable medium, said computer program configured to control a processor to perform the steps of:
switching a wireless user equipment into a mode, wherein a capability of the wireless user equipment to select a selectable access network from available access networks is restricted;
sending control instructions from an allowable access network to the wireless user equipment; and
controlling operation of the wireless user equipment based on the control instructions received from the allowable access network.

14. A system for controlling use of user equipments in the service area of an access network connected to a communication system, the system comprising:
a transmitter of a selectable access network for wireless communication of control instructions to user equipments,
wherein the user equipments are configured to have a mode of operation wherein a capability of the user equipments to select the selectable access network from available access networks is restricted and to operate based on the control instructions received from an allowable access network.

15. A system as claimed in claim 14, wherein the allowable access network is configured to serve the user equipments that are in said mode of operation and wherein the capability of the user equipments to select the selectable access network from the available access networks is restricted.

16. A system as claimed in claim 14, wherein the control instructions comprise instructions for wireless user equipments to remain in said mode wherein the capability to select the selectable access network is restricted.

17. A system as claimed in claim 14, wherein a user equipment is configured to check if the user equipment needs to operate in said mode wherein the capability to select the selectable access network is restricted subsequent to switching of the user equipment into an active state.

18. A system as claimed in claim 14, wherein a user equipment is configured to override a default operation of the user equipment by an operation in accordance with the control instructions received from the allowable access network.

19. A system as claimed in claim 14, wherein the control instructions comprise instructions regarding restrictions of use of the user equipments in the selectable access network.

20. A system as claimed in claim 14, wherein the allowable access network comprises an onboard access network of an aircraft.

21. A system as claimed in any claim 14, wherein a communication system comprises a plurality of communication networks, and wherein access networks of the communication networks and the allowable access network are provided in the form of cells of a cellular communication system.

22. An access network for serving at least one wireless user equipment that is switched into a mode wherein a capability of the at least one wireless user equipment to select a selectable access network from available access networks is restricted, the access network being configured to
send control instructions to the at least one wireless user equipment for controlling an operation of the at least one wireless user equipment for preventing inappropriate use of the at least one wireless user equipment within a service area of the access network.

23. A controller for controlling use of user equipments within an access network configured to serve at least one wireless user equipment that is switched into a mode wherein a capability of the at least one wireless user equipment to select an access network from available access networks is restricted, the controller being configured to
generate control instructions to the at least one wireless user equipment for controlling an operation of the at least one wireless user equipment for preventing inappropriate use of the at least one wireless user equipment within a service area of the access network.

24. A user equipment, comprising:
a radio part for communication with access networks, and
a controller configured to
enable switching of the user equipment into a mode wherein a capability of the user equipment to select a selectable access network from available access networks is restricted,
receive control instructions from an allowable access network via the radio part, and
control operation of the user equipment based on said control instructions received from the allowable access network.

25. A system for controlling use of a user equipment, the system comprising:
switching means for switching a wireless user equipment into a mode wherein a capability of the wireless user equipment to select a selectable access network from available access networks is restricted;
sending means for sending control instructions from an allowable access network to the wireless user equipment; and
controlling means for controlling operation of the wireless user equipment based on the control instructions received from the allowable access network.
